(19) United States
(12) Patent Application Publication
(10) Pub. No.: US 2026/0103096 A1
(43) Pub. Date: Apr. 16, 2026

(54) Locking Apparatus For A Motor Vehicle With An Emergency Release Device

(71) Applicant: Volkswagen Aktiengesellschaft, Wolfsburg (DE)

(72) Inventor: Tobias Schwarz, Wolfsburg (DE)

(73) Assignee: Volkswagen Aktiengesellschaft, Wolfsburg (DE)

(21) Appl. No.: 19/355,284

(22) Filed: Oct. 10, 2025

(30) Foreign Application Priority Data
Oct. 11, 2024 (DE) 10 2024 209 937.6

(51) Int. Cl. B60L 53/16

(52) U.S. Cl. CPC B60L 53/16; B60L 2270/32

(57) ABSTRACT

The disclosure relates to a locking apparatus for a motor vehicle, in particular a charging plug lock, which is designed to lock a charging plug to a charging socket in a form-fitting manner by means of a displaceable locking element when said locking apparatus is activated.

### CROSS-REFERENCE TO RELATED APPLICATIONS

This application claims priority to German Patent Application DE 10 2024 209 937.6, filed on Oct. 11, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a locking apparatus for a motor vehicle, for example for a charging plug lock, which is designed to lock a charging plug on a charging socket in a form-fitting manner by means of a displaceable locking element when said locking apparatus is activated. The locking apparatus may for example have a housing in which at least one activatable actuator and a gearbox connecting the actuator to the displaceable locking element are at least substantially arranged, and wherein the locking element can be displaced by the actuator into a locking position and into a release position, and with an emergency release device which has a cable pull which is connected to the locking apparatus in such a way that the locking element can be displaced into the release position by applying a pulling force to the cable pull.

### SUMMARY

A need exists to provide an improved locking apparatus. The need is addressed by the subject matter of the independent claim(s). Embodiments of the invention are described in the dependent claims, the following description, and the drawings.

### BRIEF DESCRIPTION OF THE DRAWINGS

FIG. 1 shows a locking apparatus of a charging socket in a simplified view.

FIG. 2 shows a detailed perspective view of the locking apparatus.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments of the emergency release device, the locking apparatus can be mounted in many different positions and orientations, in particular in relation to the course of the cable pull in the motor vehicle, which results in the benefit that this one locking device can be used in many different motor vehicles without having to be adapted to them. The functionality of the emergency release device is always provided.

According to the teachings herein, this is achieved in that the housing of the locking apparatus has on a housing wall an insertion funnel for the cable pull, which has a circular basic shape with an interior wall forming a feed-through opening, wherein the interior wall has a funnel radius such that the interior wall has a convex curvature, which leads to an outer edge of the insertion funnel, forming a front face of the insertion funnel at least in some regions. An insertion funnel on a housing wall is therefore assigned to the housing. The insertion funnel is initially circular in shape and is defined at least by an interior wall. The interior wall forms the actual insertion funnel by means of a funnel radius, which leads to a convex curvature of the interior wall. Due to the convex curvature, the interior wall, which is for example cylindrical in portions, in particular in a portion of the insertion funnel facing the housing wall, in order to form the feed-through opening, beneficially leads outwards towards the outer edge and always forms a guide for the cable pull, which is inserted or can be inserted into the housing of the locking apparatus through the feed-through opening of the insertion funnel. The convex curvature results in a bending radius for the cable pull in the region of the insertion funnel. This ensures that the cable pull does not have to be inserted axially into the insertion funnel, but can also be guided out of the housing outside of the housing at an angle that is inclined relative to the axial extent, in particular transversely to the axial extent. The insertion funnel thereby deflects the cable pull by, for example, 90°. The convex design of the interior wall provides that a beneficial radius is created, which enables low-friction guidance of the cable pull and thus facilitates in particular emergency unlocking due to reduced frictional forces. The circular shape also provides that the cable pull can be guided away from the insertion funnel in any direction transversely to the axial extent of the insertion funnel. This means that, regardless of the arrangement of the locking apparatus, in particular of the housing on, for example, the charging socket, the cable pull can always be guided out through the insertion funnel in any direction and safely actuated.

For example, the insertion funnel has an exterior wall that is at least partially coaxial with the interior wall and adjoins the front wall of the insertion funnel, the front all being at least partially formed by the curvature, at the outer edge. The exterior wall provides, for example, that the insertion funnel protrudes axially from the housing as a whole, so that the cable pull can also be deflected by more than 90°.

In some embodiments, the curvature protrudes axially from one end of the exterior wall in certain regions. This means that the cable pull can also be beneficially deflected through the insertion funnel by more than 90°without the cable pull rubbing against an edge of the insertion funnel, which would lead to increased wear and increased force required to unlock the locking device.

Furthermore, it is for example provided that the curvature merges into a portion, aligned perpendicular to the longitudinal extent of the insertion funnel, of the front wall, which adjoins the exterior wall. In this case, the curvature can protrude beyond the end of the exterior wall, but does not have to. In any case, the outer portion of the curvature or the front wall is aligned at a right angle or for example at least substantially at a right angle to the exterior wall. In this case, a 90°deflection of the cable pull is safely ensured and at the same time a compact design of the locking apparatus is made possible. For most applications, a 90°deflection will be sufficient to be able to mount and use the locking apparatus in many different motor vehicles.

In some embodiments, the curvature extends over the entire circumference of the insertion funnel. The curvature is constant in the circumferential direction, so that regardless of the cable pull guidance and the arrangement or orientation of the housing on the charging socket, the cable pull is always guided in the beneficial manner described above.

For example, the curvature has a funnel radius of at least 3 mm to 8 mm, or for example from 4.2 mm to 5.0 mm, or for example of 4.6 mm. This provides reduced frictional forces and beneficially cable pull guidance, which minimize the pulling force required to release the lock and at the same time ensures safe actuation.

For example, the front wall or the curvature merges into the exterior wall through a convex curve. This means that the edge between the front wall and the curvature is for example rounded or rather curved, so that the cable pull is safely prevented from getting caught on the edge in any case, thereby preventing safe operation and damage to the cable pull in any case.

In some embodiments, the insertion funnel is integrated into the housing wall. This means that the insertion funnel is part of the housing and made of the same material as the housing. This results in a cost-effective realization of the locking apparatus, which also ensures easy mounting.

In some embodiments, the insertion funnel is for example designed as a separate component and attached to the housing wall. The housing wall has an opening with which the feed-through opening of the insertion funnel is associated in order to be able to insert the cable pull directly into the housing, wherein the cable pull is for example coupled to the gearbox and/or to the locking element. The design as a separate component also has the benefit that the insertion funnel can be made of a material that is optimally matched to the cable pull in order to reduce friction between the cable pull and the insertion funnel. For example, the insertion funnel is made of a metal that provides sliding properties for the cable pull, which is for example also made of metal.

For example, the insertion funnel is made of a material that differs from the material of the housing. This allows the insertion funnel and housing to be optimally matched to their respective tasks and functions.

For example, the cable pull is connected to the gearbox at one end in order to displace the locking element into the release position when pulled. The cable pull therefore interacts with the gearbox and not directly with the locking element. If the cable pull is actuated or rather subjected to a pulling force, the gearbox is thus displaced or driven to move the locking element into the release position. Alternatively, the cable pull is directly connected to the locking element if said locking element can be moved into the release position independently of the gearbox.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

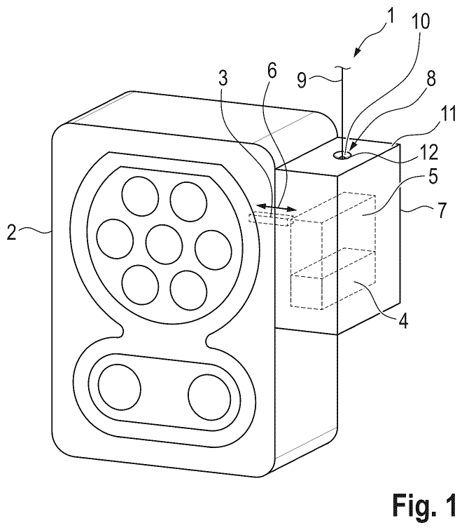

FIG. 1 shows a simplified perspective view of an activatable locking apparatus 1 for a charging socket 2 of a motor vehicle. The charging socket 2 is designed to accommodate a charging plug, not shown here, for an electrical charging process. In order to prevent unauthorized removal of the charging plug from the charging socket 2, in particular during the charging process, the locking apparatus 1 has a displaceable, in particular shiftable, locking element 3. The locking element 3 is designed to be inserted into a receptacle or opening of the charging plug when the charging plug is inserted into the charging socket 2 in order to lock the charging plug in a form-fitting manner to the charging socket 2.

For this purpose, the locking apparatus 1 also has an activatable actuator 4, in particular in the form of an electric motor. The electric motor 4 is connected to the locking element 3 in particular by a gearbox 5, wherein the gearbox 5 is designed in particular to convert the rotational movement of the electric motor 4 into a translational movement of the locking element 3, as shown by an arrow 6 in FIG. 1.

The gearbox 5 and the electric motor 4 are arranged at least substantially in a housing 7. The housing 7 is attached or can be attached, for example, to the charging socket 2.

Furthermore, the locking apparatus 1 has an emergency release device 8 which comprises a cable pull 9 which is guided out of the housing 7 of the locking apparatus 1 and leads, for example, to a handle which can be actuated by a user, for example from inside the motor vehicle, in order to apply a pulling force to the cable pull 9. The pull cable 9 is thus coupled at one end to the handle and at the other end in particular to the gearbox 5 of the locking apparatus 1, so that when a sufficiently high pulling force is applied to the cable pull 9, the locking element 3 can be displaced from the locked position interacting with the charging plug into a free position releasing the charging plug. Optionally, the cable pull 9 is a Bowden cable.

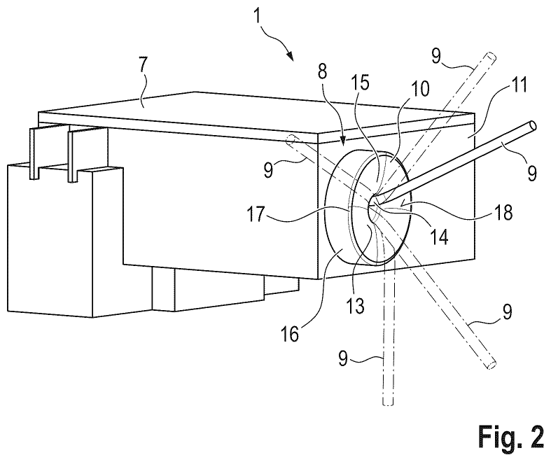

FIG. 2 shows the locking apparatus 1 according to a further exemplary embodiment in a partial perspective view. The emergency release device 8 has an insertion funnel 10, which is arranged on a housing wall 11 of the housing 7, in which an opening 12 is also formed to pass the cable pull 9 through to the gearbox 5. According to the exemplary embodiment in FIG. 2, the insertion funnel 10 is designed as a separate component and arranged on the outside of the housing wall 11. According to the exemplary embodiment in FIG. 1, the insertion funnel 10 is integrated into the housing 7 or rather the housing wall 11.

The insertion funnel has at least one interior wall 13, which is cylindrical in shape in portions and forms a feed-through opening 14 for the cable pull 9, the feed-through opening being formed so as to align or rather being oriented so as to align with the opening 12 in the housing wall 11, or forms the opening 12. The interior wall 13 has a curvature 15 with a radius R, which is for example between 4.2 and 5.0 mm, or for example 4.6 mm. The curvature 15 is convex so that it extends from the cylindrical portion of the interior wall 13 to an outer edge of the insertion funnel 10. In the exemplary embodiment in FIG. 2, the interior wall 13 or rather the curvature 15 adjoins an exterior wall 16 of the insertion funnel 10. The curvature 15 merges into the exterior wall 16 by means of a beneficial curve 17, so that no sharp edge remains between the curvature 15 and the exterior wall 16. In particular, the curve 17 continues the curvature 15 so that there is no edge at the transition from the curvature 15 to the curve 17.

In the present case, the curvature 15 extends as far as the exterior wall 16 and thus also forms a front wall 18 of the insertion funnel 10, the front wall also being convexly curved by the curvature. Because the insertion funnel 10 is for example circularly symmetrical, the curvature 15 also extends over the entire circumference of the insertion funnel 10 in a constant manner.

The beneficial design of the insertion funnel 10 provides that the cable pull 9 can continue in any direction outside of the housing 7 or rather of the insertion funnel 10 without changing the operating properties of the emergency release device 8. The beneficial insertion funnel 10 thus allows the cable pull 9 to be deflected by at least 90°in relation to the axial extent of the feed-through opening. The circular symmetry provides that the cable pull 9 can be guided out in any direction and can also be deflected by at least 90°.

For example, the insertion funnel 10 according to the exemplary embodiment in FIG. 2 is made of a material that differs from the material of the housing 7, so that the housing 7 on the one hand and the insertion funnel 10 on the other hand can be optimally switched off for their respective functions with regard to the choice of material. The insertion funnel 10 has in particular a material that provides a beneficially low coefficient of friction for the cable pull 9, while the housing 7 is optimized, for example, in terms of its stability and tightness.

Because the cable pull 9 is inserted directly into the housing and thus interacts with the actuator 4 and/or the gearbox 5 and/or the locking element 3 within the housing 7, the locking device 1 with emergency release device 8 is beneficially designed to reduce installation space, wherein the emergency release device 8 also lies within the housing 7 such that it is largely protected from external influences. This minimizes the effort required to seal and protect the emergency release device 8 itself.

The design of the insertion funnel 10 means that the locking apparatus 1 can be arranged on the charging socket 2 in a wide variety of orientations and arrangements, thus ensuring a high degree of flexibility in terms of arrangement and orientation. This means that the locking apparatus 1 can be used on many different charging sockets 2 of different motor vehicles.

While according to the present exemplary embodiment the locking apparatus 1 is assigned to the charging socket 2, according to a further exemplary embodiment not shown here it is provided that the locking apparatus 1 is attached to or arranged on the charging plug.

### LIST OF REFERENCE NUMERALS

1 Locking apparatus
2 Charging socket
3 Locking element
4 Actuator
5 Gearbox
6 Arrow
7 Housing
8 Emergency release device
9 Cable pull
10 Insertion funnel
11 Locking apparatus
12 Opening
13 Interior wall
14 Feed-through opening
15 Curvature
16 Exterior wall
17 Curve
18 Front wall

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example”or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A locking apparatus for a motor vehicle, in particular a charging plug lock, which is designed to lock a charging plug to a charging socket in a form-fitting manner using a displaceable locking element when said locking apparatus is activated, wherein the locking apparatus has a housing, in which at least one activatable actuator and a gearbox connecting the actuator to the displaceable locking element are at least substantially arranged, and wherein the locking element can be displaced by the actuator into a locking position and into a release position, and with an emergency release device, which has a cable pull which is connected to the locking apparatus in such a way that the locking element can be displaced into the release position by applying a pulling force to the cable pull; wherein the housing has on a housing wall an insertion funnel for the cable pull, which has a circular basic shape with an interior wall forming a feed-through opening, wherein the interior wall has a funnel radius such that the interior wall has a convex curvature which leads to an outer edge of the insertion funnel, forming a front wall of the insertion funnel at least in certain regions.

2. The locking apparatus of claim 1, wherein the insertion funnel has an exterior wall which is formed at least in portions coaxially with the interior wall and, at the outer edge, adjoins the front wall of the insertion funnel.

3. The locking apparatus of claim 1, wherein the curvature protrudes axially in some regions from one end of the exterior wall.

4. The locking apparatus of claim 1, wherein the curvature merges into a portion, aligned perpendicular to the longitudinal extent of the insertion funnel, of the front wall, which adjoins the exterior wall.

5. The locking apparatus of claim 1, wherein the curvature extends over the entire circumference of the insertion funnel.

6. The locking apparatus of claim 1, wherein the funnel radius of the curvature is a radius of at least 3 mm to 8 mm.

7. The locking apparatus of claim 1, wherein the front wall or the curvature merges into the exterior wall by means of a convex curve.

8. The locking apparatus of claim 1, wherein the insertion funnel is integrated into the housing wall.

9. The locking apparatus of claim 1, wherein the insertion funnel is designed as a separate component and is attached to the housing wall.

10. The locking apparatus of claim 1, wherein the insertion funnel is made of a material that differs from the material of the housing.

11. The locking apparatus of claim 1, wherein the cable pull is connected at one end to the gearbox in order to displace the locking element into the release position when pulled.

12. The locking apparatus of claim 2, wherein the curvature protrudes axially in some regions from one end of the exterior wall.

13. The locking apparatus of claim 2, wherein the curvature merges into a portion, aligned perpendicular to the longitudinal extent of the insertion funnel, of the front wall, which adjoins the exterior wall.

14. The locking apparatus of claim 3, wherein the curvature merges into a portion, aligned perpendicular to the longitudinal extent of the insertion funnel, of the front wall, which adjoins the exterior wall.

15. The locking apparatus of claim 2, wherein the curvature extends over the entire circumference of the insertion funnel.

16. The locking apparatus of claim 3, wherein the curvature extends over the entire circumference of the insertion funnel.

17. The locking apparatus of claim 4, wherein the curvature extends over the entire circumference of the insertion funnel.

18. The locking apparatus of claim 2, wherein the curvature extends over the entire circumference of the insertion funnel.

19. The locking apparatus of claim 3, wherein the curvature extends over the entire circumference of the insertion funnel.

20. The locking apparatus of claim 4, wherein the curvature extends over the entire circumference of the insertion funnel.
